(19) United States
(12) Patent Application Publication
(10) Pub. No.: US 2018/0370086 A1
(43) Pub. Date: Dec. 27, 2018

(54) Female Die for Manufacturing Wall Thickness-variable Glove and Glove Manufactured Using Female Die

(71) Applicant: INSTITUTE OF MATERIALS, CHINA ACADEMY OF ENGINEERING PHYSICS, Mianyang, Sichuan (CN)

(72) Inventors: Pengcheng ZHANG, Mianyang, Sichuan (CN); Duigong XU, Mianyang, Sichuan (CN); Yichuan LIAO, Mianyang, Sichuan (CN)

(21) Appl. No.: 15/779,408

(22) PCT Filed: Nov. 10, 2016
(86) PCT No.: PCT/CN2016/105261

§ 371 Date: May 25, 2018

(30) Foreign Application Priority Data
Nov. 25, 2015 (CN) 201510831861.9

(51) Int. Cl. B29C 41/40; A41D 19/04; A41D 19/00

(52) U.S. Cl. CPC B29C 41/40; B29K 2105/0064; A41D 19/0058; A41D 19/04

(57) ABSTRACT

A female die for manufacturing a wall thickness-variable glove and a glove manufactured using the female die. The female die for a wall thickness-variable glove comprises a base (1), an arm portion (2), a palm portion (3), and finger portions. The base (1), the arm portion (2), the palm portion (3) and the finger portions are connected in sequence. The palm portion (3) comprises a palm center member (4) and a palm back member (5) connected to the palm center member (4). The die can be adopted for effectively thickening a hand back portion of the manufactured glove, and therefore the flexibility of other portions of the glove is guaranteed on the premise of effectively protecting the hand back of a doctor, the requirement for protection of the hand back of the doctor under an environment such as an interventional operation is met, and the characteristics of protection and use flexibility are both achieved.

### FIELD

The present invention relates to the field of protective equipment, in particular to the field of radiation protection products, and in particular to a female die for manufacturing a wall thickness-variable glove and a glove manufactured using the female die. The female die may be used for manufacturing a wall thickness-variable protective glove, especially for manufacturing a wall thickness-variable X-ray protective glove. The manufactured glove may be used for protecting the hand back of a doctor in an interventional operation or orthopedic operation, and has better protective effects and application prospects.

### BACKGROUND

Radiation protection rubber gloves used in the nuclear industry and nuclear medicine are iso-wall thickness gloves, which are generally manufactured by integral dipping using general glove dies. In order to achieve a better protective effect, gloves that are manufactured by integral dipping using general glove dies are generally thick and may affect the hand feeling of doctors in operations.

Chinese patent CN97225793.4 discloses an easy release film glove die. The glove die has a palm portion with a rough surface, and the rough surface is composed of evenly distributed arc-shaped concave parts, which allows easy release of the film glove.

Chinese patent CN200620124744.5 discloses a dipping stainless steel glove die. The glove die is of integral structure. An arm support is arranged at an arm portion of the die. The die is characterized by simple manufacture.

Chinese patent CN201410578601.0 discloses a die for manufacturing a TPE glove. The die comprises a palm die and an arm die. A concave ring groove is formed on the arm die, and a sleeve portion of the glove manufactured using the die is closed up. The glove manufactured using the die may be easily tightened on an arm of a user.

### SUMMARY

The applicant has found through research that X-ray causes the most serious radiation damage to the hand backs of surgeons in the clinical application of X-ray machines. However, the existing iso-wall thickness lead protective gloves have poor flexibility in use and cannot meet the needs of doctors for flexible operations. Therefore, doctors are often reluctant to wear the existing iso-wall thickness lead protective gloves. As a result, there is an urgent need to develop a protective glove that has good X-ray protective effects and may meet the requirements of doctors for flexible operations, i.e., a wall thickness-variable glove. Therefore, the utility model provides a die for manufacturing a wall thickness-variable glove.

With regard to the current problem that wall thickness-variable gloves cannot be manufactured as the existing iso-wall thickness X-ray protective gloves are manufactured by dipping using general dies, the purpose according to the present invention is to provide a female die for manufacturing a wall thickness-variable glove and a glove manufactured using the female die. The use of the female die according to the present invention may achieve local thickening of the glove, thereby guaranteeing the flexibility of the glove on the premise of effective protection. In addition, the wall thickness-variable glove manufactured using the female die according to the present invention may achieve local thickening of a hand back portion of the glove, so that the requirement for protection of the hand back of a doctor under an environment such as an interventional operation is met, especially the requirement for protection against X-ray may be met. The present invention has the advantages of reasonable design and convenient use, and the wall thickness-variable glove manufactured by one-time dipping has good application prospects.

In order to achieve the purpose, the present invention adopts the following technical solution: A female die for manufacturing a wall thickness-variable glove, characterized by comprising a base, an arm portion, a palm portion and finger portions, wherein the base, the arm portion, the palm portion and the finger portions are connected in sequence, the palm portion comprises a palm center member and a palm back member connected to the palm center member, the finger portions comprise a thumb member, a forefinger member, a middle finger member, a ring finger member and a little finger member, and a first groove with a depth of 0.3-1.5 mm is formed on the palm back member; the thumb member is provided with a second groove at one side of the palm back member, or the forefinger member is provided with a second groove at one side of the palm back member, or the thumb member, the forefinger member, the middle finger member, the ring finger member and the little finger member are provided with a second groove at one side of the palm back member respectively;
the second groove with a depth of 0.3-1.5 mm is connected with the first groove;
and surfaces of the first groove and the second groove are respectively provided with a hydrophilic coating with a thickness of 1-300 μm.

The palm center member and the palm back member are integrally formed.

The arm portion and the palm portion are hollow structures.

The arm portion, the palm portion and the finger portions are made of a ceramic material or a metal material respectively.

The area of the second groove on the thumb member is 0.1-0.7 time that of the thumb member at one side of the palm back member.

The area of the second groove on the forefinger member is 0.1-0.7 time that of the forefinger member at one side of the palm back member.

The area of the second groove on the thumb member, the forefinger member, the middle finger member, the ring finger member and the little finger member is 0.1-0.7 time that of the thumb member, the forefinger member, the middle finger member, the ring finger member and the little finger member at one side of the palm back member respectively.

The hydrophilic coating has a contact angle of 2-30°.

A glove manufactured using the female die for manufacturing a wall thickness-variable glove. With regard to the problem, the present invention provides a female die for manufacturing a wall thickness-variable glove and a glove manufactured using the female die. The female die comprises a base, an arm portion, a palm portion and finger portions. The base, the arm portion, the palm portion and the finger portions are connected in sequence. The palm portion comprises a palm center member and a palm back member connected to the palm center member, the finger portions comprise a thumb member, a forefinger member, a middle finger member, a ring finger member and a little finger member, and a first groove with a depth of 0.3-1.5 mm is formed on the palm back member. The die may be adopted for effectively thickening a hand back portion of the manufactured glove, and therefore the flexibility of other portions of the glove is guaranteed on the premise of effectively protecting the hand back of a doctor, and the characteristics of protection and use flexibility are both achieved, thus the die has good application prospects. The female die provided by the present invention may be used for manufacturing a wall thickness-variable glove, so as to achieve local thickening of a hand back portion of the glove, and meet the requirement for protection of the hand back of a doctor under an environment such as an interventional operation.

Further, the thumb member is provided with a second groove at one side of the palm back member, or the forefinger member is provided with a second groove at one side of the palm back member; and the second groove with a depth of 0.3-1.5 mm is connected with the first groove. Or the thumb member, the forefinger member, the middle finger member, the ring finger member and the little finger member are provided with a second groove at one side of the palm back member respectively, and the second groove with a depth of 0.3-1.5 mm is connected with the first groove. The area of the second groove on the thumb member, the forefinger member, the middle finger member, the ring finger member and the little finger member is 0.1-0.7 time that of the thumb member, the forefinger member, the middle finger member, the ring finger member and the little finger member at one side of the palm back member respectively. With the structure, a rear half finger back and the palm back member of the female die are depressed, thinner than a front half finger back of the fingers, and gradually depressed with a slope to form a 0.3-1.5 mm deep shallow groove (i.e., the first groove and the second groove) capable of holding a latex. The hand back and the rear half fingers connected to the hand back of the glove manufactured using the die are locally thickened, and other portions are thin, therefore the hand back and the rear half fingers are effectively protected while the flexibility of the glove is guaranteed, thus the glove has good protective effects.

Further, surfaces of the first groove and the second groove are respectively provided with a hydrophilic coating with a thickness of 1-300 The hydrophilic coating has a contact angle of 2-30°. The hydrophilicity or wettability of a solid surface is determined by chemical composition and micromorphology of the surface, and is generally measured by the size of the contact angle. The contact angle refers to the angle formed at the three-phase boundary by liquid droplets dripping on a solid surface. In general, a surface with a contact angle of <90° is defined as a hydrophilic surface, which appears as a surface that may be wetted with water; on the contrary, a surface with a contact angle of >90° is defined as a hydrophobic surface, the surface cannot be wetted with water; when the contact angle of a surface is close to 0°, the surface is called a superhydrophilic surface. Surfaces of the first groove and the second groove according to the present invention are respectively provided with a hydrophilic coating, thereby forming a porous water-absorbing surface. Due to the arrangement of the hydrophilic coating, the contact angle of the surfaces of the first groove and the second groove is 2-30°, while the other surfaces of the female die are not provided with a hydrophilic coating, so that the contact angle of other surfaces than the shallow groove (i.e., the first groove and the second groove) of the female die is 30-70°. Based on the above structure, the hydrophilicity or wettability of the surfaces of the first groove and the second groove is superior to the surface of other portions, thus the structure is more hydrophilic and capable of carrying more coagulant and latex. When the glove is manufactured using the female die according to the present invention, one-time dipping forming may be achieved. Brief steps for manufacturing a wall thickness-variable glove using the female die are described as follows: (1) the female die is cleaned and dried, then dipped with a coagulant and dried; (2) the female die treated in step (1) is dipped with a rubber latex or emulsion, then set and dried to obtain an initial blank; (3) the female die treated in step (2) is vulcanized, released and dried to obtain a finished glove product of which the hand back portion is thickened and other portions are thinner.

The female die according to the present invention may be used for manufacturing a wall thickness-variable protective glove, especially for manufacturing a wall thickness-variable x-ray protective glove. The manufactured glove may be used for protecting the hand back of a doctor in an interventional operation or orthopedic operation, and has better protective effects and application prospects.

Further, the arm portion and the palm portion are hollow structures, and the palm center member and the palm back member are integrally formed. The hollow structures help reduce the mass of the die. The arm portion, the palm portion and the finger portions are made of a ceramic material or a metal material respectively. The female die may be made of a ceramic material by isostatic pressing, conventional casting, investment casting, sintering, or hot injection molding; or the female die may be made of a metal material by electroforming, conventional casting, machining, investment casting or rapid prototyping.

Based on the above structure, the mechanism for realizing local thickening of the glove according to the present invention is mainly based on the following three aspects: first, the first groove and the second groove may hold more latex, thus the thickening is achieved; second, the surfaces of the first groove and the second groove are more hydrophilic and may carry more latex; third, the surfaces of the first groove and the second groove are more hydrophilic and may carry more coagulant, and the coagulant has good water absorbability and may carry more latex after latex dipping. With the three aspects, the female die according to the present invention may better achieve local thickening of the glove, and may be used for manufacturing a wall thickness-variable glove with good protective effects and flexible operation.

Further, the present invention provides a glove manufactured using the female die for manufacturing a wall thickness-variable glove. The thickness of the thickened portion of the glove may be 0.3-2.5 mm, and the thickness of unthickened portions may be 0.1-0.3 mm.

In conclusion, a wall thickness-variable glove may be manufactured using the female die according to the present invention, and the manufactured protective glove has the characteristics of good protective effects and flexible operation, and may particularly satisfy the requirement of protection against X-ray. The female die according to the present invention may achieve local protection through the design of the first groove and the second groove, and finger pulp portions are thinner so as to ensure the flexibility of operation. The glove manufactured using the female die according to the present invention is particularly suitable for interventional operations and orthopedic operations, the flexibility of the glove may be guaranteed on the premise of effective protection, thereby providing the general medical workers with practical and effective protection. The thickness of the thickened portion of the glove manufactured in the present invention may be 0.3-2.5 mm, and the thickness of unthickened portions may be 0.1-0.3 mm.

### DESCRIPTION OF THE DRAWINGS

The present invention will be described in combination with examples and accompanied drawings, in which:

FIG. 1 is a side view of example 1;

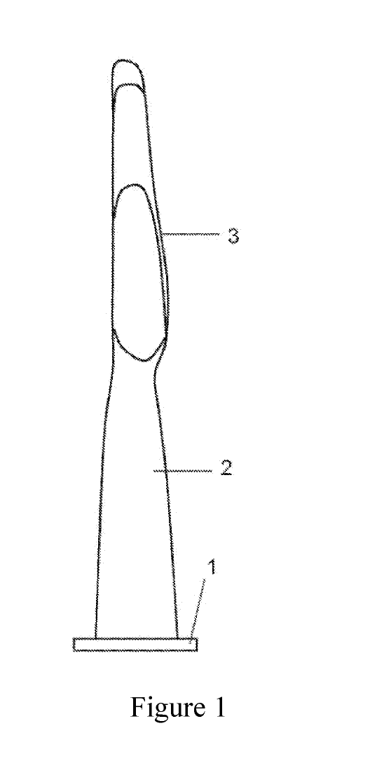

FIG. 2 is a front view of FIG. 1;

FIG. 3 is a sectional view of FIG. 2 in A-A direction;

FIG. 4 is a sectional view of FIG. 2 in B-B direction;

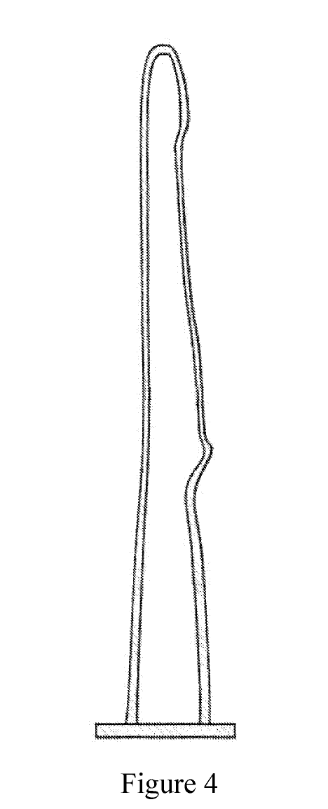

FIG. 5 is a front view of example 2;

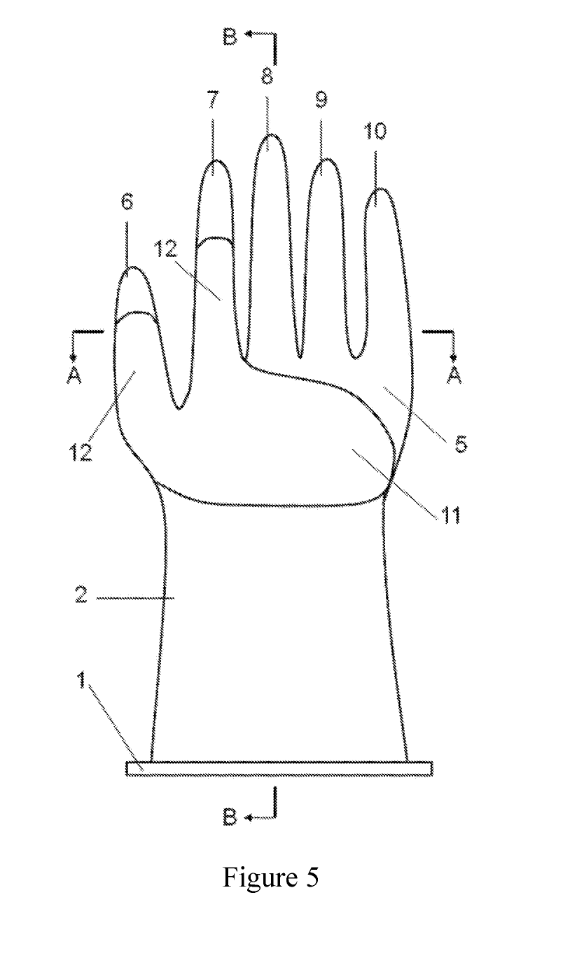

FIG. 6 is a sectional view of FIG. 5 in A-A direction; and

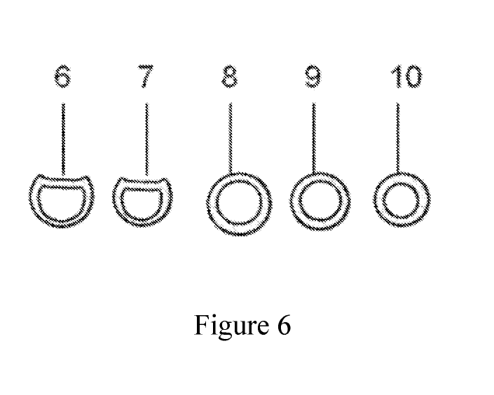

FIG. 7 is a sectional view of FIG. 5 in B-B direction.

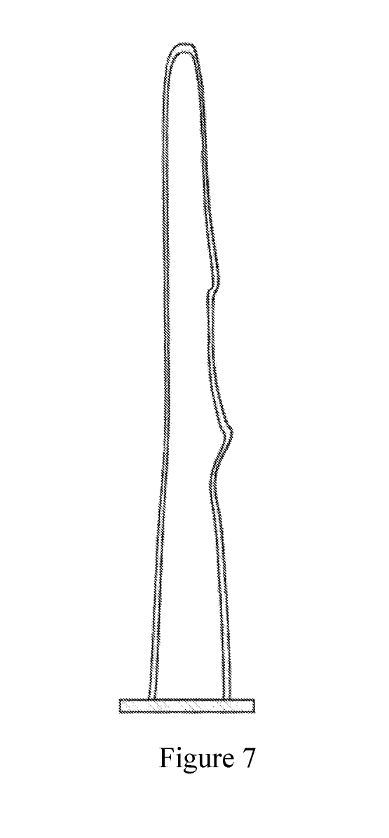

Marks in the figures: 1—base, 2—arm portion, 3—palm portion, 4—palm center member, 5—palm back member, 6—thumb member, 7—forefinger member, 8—middle finger member, 9—ring finger member, 10—little finger member, 11—first groove, 12—second groove.

### DESCRIPTION OF THE PREFERRED EMBODIMENT

All features or steps in all methods and procedures disclosed in the specification may be combined in any way, except mutually exclusive features and/or steps.

Any feature disclosed in the specification may be replaced with other equivalent or similar features, unless otherwise specified, that is, each feature is only an example of series of equivalent or similar features, unless otherwise specified.

### Example 1

As shown in the figures, the female die comprises a base, an arm portion, a palm portion and finger portions. The base, the arm portion, the palm portion and the finger portions are connected in sequence as a whole. The arm portion and the palm portion are hollow structures. The finger portions comprise a thumb member, a forefinger member, a middle finger member, a ring finger member and a little finger member.

A first groove is formed on a palm back member. The thumb member, the forefinger member, the middle finger member, the ring finger member and the little finger member are provided with a second groove at one side of the palm back member respectively, and the second groove is connected with the first groove. The depth of the first groove and the second groove is 0.3-1.5 mm respectively. The area of the second groove on the thumb member, the forefinger member, the middle finger member, the ring finger member and the little finger member is 0.5 time that of the thumb member, the forefinger member, the middle finger member, the ring finger member and the little finger member at one side of the palm back member respectively. Surfaces of the first groove and the second groove are respectively provided with a hydrophilic coating with a thickness of 1-300 μm.

In the example, the female die is made of a Al₂O₃ ceramic material by investment casting, and the contact angle of the surface of the female die is 30-70°. The hydrophilic coating is prepared from a TiO₂ ceramic material by plasma spraying. The hydrophilic coating forms a porous water-absorbing surface with a contact angle of 2-30°.

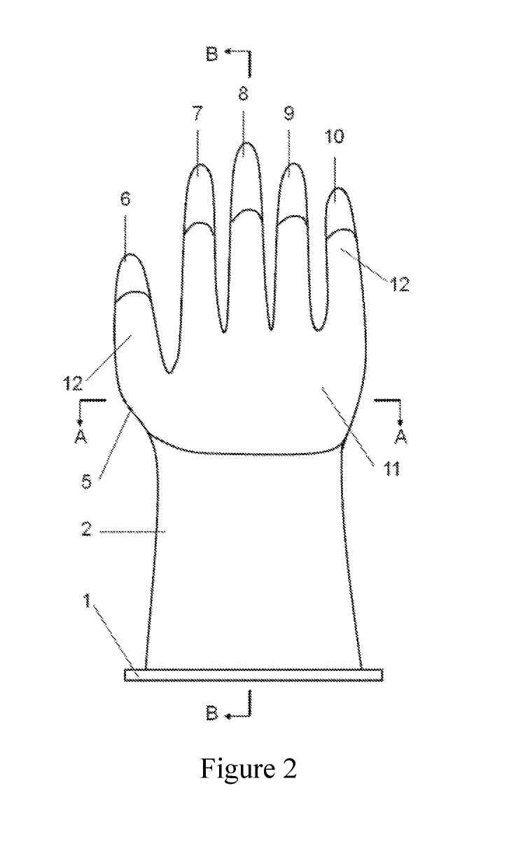

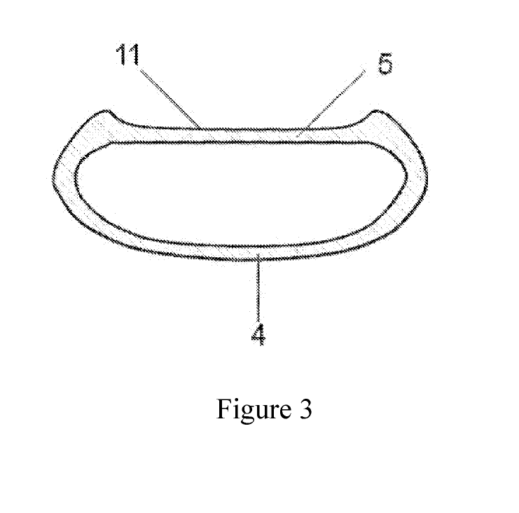

In the example, the thumb member, the forefinger member, the middle finger member, the ring finger member and the little finger member are provided with a second groove at one side of the palm back member respectively, that is, the front half finger back of the finger portions has a normal thickness, and the rear half finger back connected to the hand back is depressed, thus achieving thickening of the finger portions of the glove. FIG. 3 is a sectional view of FIG. 2 in A-A direction. As may be seen from FIG. 3, a first groove is formed on the palm back member, and the palm back portion of the glove may be thickened by the first groove. Further, the base is provided with a connecting hole, the connecting hole is a through hole or a threaded hole which helps fix the base to the base. Further, the steps for manufacturing the glove using the female die of the example are as follows.
(1) The female die is cleaned and dried, then dipped in a coagulant and dried, the coagulant is an aqueous CaCl₂) solution with a mass fraction of 3-20%.
(2) The female die treated in step (1) is dipped with an emulsion, then set and dried. Typically but unrestrictedly, the dipping emulsion is mainly composed of a natural rubber latex, a compounding agent and a slurry containing a radiation protection material Bi₂O₃, and the compounding agent is mainly composed of a vulcanizing agent, a vulcanization accelerator, an antioxidant, a reinforcing agent and soft water.
(3) The female die treated in step (2) is vulcanized, released and dried to obtain a finished glove product.

The thickness of the thickened portion of the glove manufactured in the example is 0.3-2.5 mm, and the thickness of unthickened portions is 0.1-0.3 mm.

### Example 2

As shown in the figures, the female die comprises a base, an arm portion, a palm portion and finger portions. The base, the arm portion, the palm portion and the finger portions are connected in sequence as a whole. The arm portion and the palm portion are hollow structures. The finger portions comprise a thumb member, a forefinger member, a middle finger member, a ring finger member and a little finger member.

In the example, a first groove is formed on a palm back member. The thumb member and the forefinger member are provided with a second groove at one side of the palm back member respectively, and the second groove is connected with the first groove. The depth of the first groove and the second groove is 0.3-1.5 mm respectively. Different from example 1, in the example, only the thumb member and the forefinger member are provided with a second groove respectively. The area of the second groove on the thumb member and the forefinger member is 0.5 time that of the thumb member and the forefinger member at one side of the palm back member respectively. Surfaces of the first groove and the second groove are respectively provided with a hydrophilic coating with a thickness of 100-200 μm.

In the example, the female die is made of stainless steel by investment casting, and the contact angle of the surface of the female die is 30-70°. The hydrophilic coating is prepared from stainless steel by plasma spraying. The hydrophilic coating forms a porous water-absorbing surface with a contact angle of 2-30°.

Further, the steps for manufacturing the glove using the female die of the example are as follows.
(1) The female die is cleaned and dried, then dipped in a coagulant and dried, the coagulant is an aqueous CaCl₂) solution with a mass fraction of 3-20%.
(2) The female die treated in step (1) is dipped with an emulsion, then set and dried. Typically but unrestrictedly, the dipping emulsion is mainly composed of a carboxylic butadiene-acrylonitrite latex, a compounding agent and a slurry containing a radiation protection material WO₃, and the compounding agent is mainly composed of a vulcanizing agent, a vulcanization accelerator, a reinforcing agent and soft water.
(3) The female die treated in step (2) is vulcanized, released and dried to obtain a finished glove product.

The thickness of the thickened portion of the glove manufactured in the example is 0.3-2.5 mm, and the thickness of unthickened portions is 0.1-0.3 mm.

With convenient, simple and quick operation, the female die of the example may be used to manufacture a wall thickness-variable glove by one-time dipping. The manufactured wall thickness-variable glove may effectively protect doctors on the premise of ensuring flexible operation, and may particularly satisfy the requirement of protection against X-ray, and has good application prospects. The present invention is not limited to the embodiments, and expands to any new feature or any new combination disclosed in the specification, and steps in any new method or procedure or any new combination disclosed.

1. A female die for manufacturing a wall thickness-variable glove, characterized by comprising a base (1), an arm portion (2), a palm portion (3) and finger portions, wherein the base (1), the arm portion (2), the palm portion (3) and the finger portions are connected in sequence, the palm portion (3) comprises a palm center member (4) and a palm back member (5) connected to the palm center member (4), the finger portions comprise a thumb member (6), a forefinger member (7), a middle finger member (8), a ring finger member (9) and a little finger member (10), and a first groove (11) with a depth of 0.3-1.5 mm is formed on the palm back member (5);
the thumb member (6) is provided with a second groove (12) at one side of the palm back member (5), or the forefinger member (7) is provided with a second groove (12) at one side of the palm back member (5), or the thumb member (6), the forefinger member (7), the middle finger member (8), the ring finger member (9) and the little finger member (10) are provided with a second groove (12) at one side of the palm back member (5) respectively;
the second groove (12) with a depth of 0.3-1.5 mm is connected with the first groove (11);
and surfaces of the first groove (11) and the second groove (12) are respectively provided with a hydrophilic coating with a thickness of 1-300 μm.

2. The female die for manufacturing a wall thickness-variable glove according to claim 1, characterized in that the palm center member (4) and the palm back member (5) are integrally formed.

3. The female die for manufacturing a wall thickness-variable glove according to claim 1, characterized in that the arm portion (2) and the palm portion (3) are hollow structures.

4. The female die for manufacturing a wall thickness-variable glove according to claim 1, characterized in that the arm portion (2), the palm portion (3) and the finger portions are made of a ceramic material or a metal material respectively.

5. The female die for manufacturing a wall thickness-variable glove according to claim 1, characterized in that the area of the second groove (11) on the thumb member (6) is 0.1-0.7 time that of the thumb member (6) at one side of the palm back member (5).

6. The female die for manufacturing a wall thickness-variable glove according to claim 1, characterized in that the area of the second groove (11) on the forefinger member (7) is 0.1-0.7 time that of the forefinger member (7) at one side of the palm back member (5).

7. The female die for manufacturing a wall thickness-variable glove according to claim 1, characterized in that the area of the second groove (12) on the thumb member (6), the forefinger member (7), the middle finger member (8), the ring finger member (9) and the little finger member (10) is 0.1-0.7 time that of the thumb member (6), the forefinger member (7), the middle finger member (8), the ring finger member (9) and the little finger member (10) at one side of the palm back member (5) respectively.

8. The female die for manufacturing a wall thickness-variable glove according to claim 1, characterized in that the hydrophilic coating has a contact angle of 2-30°.

9. A glove manufactured using the female die for manufacturing a wall thickness-variable glove according to claim 1.
